(19) United States
(12) Patent Application Publication
(10) Pub. No.: US 2020/0189559 A1
(43) Pub. Date: Jun. 18, 2020

(54) METHOD FOR COMPENSATING FOR NO-LOAD LOSSES IN AN ELECTRIC VEHICLE, COMPUTER PROGRAM PRODUCT, DATA CARRIER, AND ELECTRIC VEHICLE

(71) Applicant: VOLKSWAGEN AKTIENGESELLSCHAFT, Wolfsburg (DE)

(72) Inventors: Michael ANIS, Wolfsburg (DE); Rainer WREDE, Wolfsburg (DE)

(73) Assignee: VOLKSWAGEN AKTIENGESELLSCHAFT, Wolfsburg (DE)

(21) Appl. No.: 16/603,023

(22) PCT Filed: Mar. 26, 2018
(86) PCT No.: PCT/EP2018/057570

§ 371 Date: Oct. 4, 2019

(30) Foreign Application Priority Data
Apr. 6, 2017 (DE) 10 2017 205 871.4

(51) Int. Cl. B60W 20/10; B60K 6/28; B60K 6/26; B60K 6/24; B60K 1/02; B60L 15/20; B60L 58/12; B60L 50/60; B60W 10/06; B60W 10/08

(52) U.S. Cl. CPC B60W 20/10; B60K 6/28; B60K 6/26; B60K 6/24; B60K 1/02; B60Y 2200/92; B60L 58/12; B60L 50/66; B60W 10/06; B60W 10/08; B60Y 2200/91; B60L 15/2045

(57) ABSTRACT

The present invention relates to a method for compensating for no-load losses in an electric vehicle comprising a first drive unit in the form of an electric machine which is supplied with power by at least one battery of the electric vehicle for driving the electric vehicle, and a second drive unit for driving the electric vehicle. In a no-load operation of the first drive unit, in which the first drive unit is to provide neither a positive nor a negative moment, the no-load losses at the first drive unit are compensated for to a different degree, depending on route data and/or vehicle data of the electric vehicle. The invention further relates to a computer program product for carrying out the method according to the invention, to a data carrier on which the computer program product is stored, and to an electric vehicle.

The present invention relates to a method for compensating for no-load losses in an electric vehicle having a first drive unit constituted as an electric machine, as well as a second drive unit for driving the electric vehicle. The present invention also relates to a computer program product, as well as to a data carrier having a computer program product stored thereon. Moreover, the present invention relates to an electric vehicle having a first drive unit constituted as an electric machine, as well as a second drive unit for driving or decelerating the electric vehicle.

The German Patent Application DE 10 2013 112 388 A1 discusses a hybrid electric vehicle having a combustion engine and a plurality of generators, as well as electric motors for a serial or parallel operating mode. In particular, the German Patent Application DE 10 2013 112 388 A1 describes a drivetrain of a hybrid electric vehicle that is designed as a hybridized drivetrain for a plurality of different drive motors. In various operating states of the drivetrain, a combustion engine, as well as at least one electric machine are used. These machines are differently integrated or coupled, depending on the operating state. In various operating states, the machines are functionally integrated into the drivetrain individually or in groups. The operating states are adapted to the particular demands of the hybrid electric vehicle operation. The one or the plurality of electric machines may thereby be operated both as drive motors, and as electric generators. The present invention also relates to a suitable method for operating the drivetrain. Derived accordingly from the German Patent Application DE 10 2013 112 388 A1 are a device and a method via which the various machines of the motor vehicle can drive the drivetrain in a predefined manner as a function of a load demand on the same.

In an electric vehicle, an electric machine can be operated in an operating state where, in accordance with a driver's demand, it is to provide neither a positive nor a negative torque for driving, respectively accelerating or decelerating the hybrid electric vehicle, in an electrically or mechanically neutral manner, it being necessary to compensate for no-load losses in this operating state. This operating state can be understood as a no-load operation of the respective electric machine.

If the electric machine is operated in a mechanically neutral manner in this operating state in what is generally referred to as zero torque control, then electric power is required for this purpose and must be supplied by the system. In the case of frequent use, this can lead to an excessive discharging of a vehicle battery, which is provided for the electric power needed. If the electric machine is operated in an electrically neutral manner by what is commonly known as a zero current control, then the internal combustion engine must entrain the electric machine for this operating state. This leads to an increased fuel consumption, which should be avoided whenever possible.

It is an object of the present invention to take the aforementioned problem into account, at least partially. In particular, it is an object of the present invention to provide a method, a computer program product, a data carrier having the computer program product, as well as an electric vehicle, via which no-load losses may be reliably and efficiently compensated in an electric machine of the electric vehicle in an operating state of the electric machine, in which the electric machine is to provide neither a positive nor a negative torque.

The aforementioned objective is achieved by the claims. In particular, the aforementioned objective is achieved by the method according to claim 1, the computer program product according to claim 9, the data carrier according to claim 10, as well as the electric vehicle according to claim 11. Further advantages of the present invention are derived from the dependent claims, the description and the drawing. It is thereby self-evident that features described in connection with the method also apply in connection with the computer program product according to the present invention, the data carrier according to the present invention, the electric vehicle according to the present invention and, respectively, the other way around, so that the disclosure of the particular inventive aspects will or may always be referred to reciprocally.

In accordance with a first aspect of the present invention, a method is provided for compensating for no-load losses in an electric vehicle having a first drive unit constituted as an electric machine, which at least one battery of the electric vehicle supplies with power for a propulsion of the electric vehicle, as well as a second drive unit for driving the electric vehicle. In the method, no-load losses in the first drive unit in a no-load operation of the first drive unit, in which the first drive unit is to provide neither a positive nor a negative torque, are variably compensated as a function of predictive route data and/or vehicle data of the electric vehicle.

In the context of the present invention, it was ascertained that no-load losses in an electric vehicle are able to be very reliably and efficiently compensated on the basis of the predictive route data and/or the vehicle data. It is thus possible, for example, to compensate for no-load losses in the first drive unit, respectively in the electric machine as a function of a tank level of a fuel tank for an internal combustion engine, which is designed as the second drive unit, as a function of a general operating state of the internal combustion engine and/or as a function of an operating state of the drivetrain of the electric vehicle.

Adaptively compensating for no-load losses makes it possible to economically, respectively efficiently and reliably use various energy accumulators of the electric vehicle, i.e., for example, the fuel tank and/or the at least one battery for the electric machine.

The battery is understood, in particular, to be a power battery for supplying current and/or voltage to the electric machine to drive the electric vehicle. Besides this electric machine, the battery may also supply other electric machines with electric power. Besides the first drive unit, respectively the corresponding electric machine, it is also possible to compensate for no-load losses of other electric machines of the electric vehicle.

The electric vehicle may be designed as a hybrid electric vehicle having an internal combustion engine or as a pure electric vehicle having a plurality of electric machines. When the electric vehicle is designed as a hybrid electric vehicle, the second drive unit may be constituted as an internal combustion engine. When the electric vehicle is a pure electric vehicle, the second drive unit may be constituted as another electric machine. The electric vehicle is, therefore, a motor vehicle having at least one electric machine.

If no-load losses are variably compensated, the internal combustion engine operates the electric machine in an electrically neutral manner or the battery operates it in a mechanically neutral manner as a function of the predictive route data, the vehicle data and/or the second drive unit used. Variable compensation is understood to preferably be the compensation of no-load losses using different energy sources. If, for example, first defined, predictive route data are ascertained, the no-load losses are compensated using a corresponding first energy source. If, for example, second, defined predictive route data are ascertained, which differ from the first defined, predictive route data, the no-load losses are compensated using a corresponding second energy source.

Upon compensation of the no-load losses, entrainment losses, which arise in the first drive unit in the no-load operation of the electric vehicle, are compensated.

No-load losses may be understood to be torques that occur in response to a necessary entrainment of the electric machine in an operating state in which the electric machine is to provide neither a positive nor a negative torque.

Predictive route data may be understood to be various influencing factors that may have an effect on the electric vehicle in the course of a predictable drive thereof. Such influencing factors may include environmental influences, such as rainfall, temperature or air humidity. Thus, in the no-load state, the electric machine may be variably compensated as a function of whether it is snowing, the sun is shining, it is hot, cold, raining, whether it has a high and/or a low air humidity. Driving the electric vehicle is understood, in particular, to be accelerating or decelerating the same.

In a refined embodiment of the present invention, the vehicle data to be considered preferably show a charge state of the at least one battery of the electric vehicle, no-load losses being compensated as a function of the charge state of the at least one battery. Moreover, it is possible that the predictive route data reveal an elevation profile of a predicted route of the electric vehicle, and that no-load losses are compensated as a function of the predicted elevation profile. Moreover, the predictive route data may also reveal a speed profile of the electric vehicle, and no-load losses may be compensated as a function of the predicted speed profile of the electric vehicle. The energy resources of the electric vehicle may be used very efficiently on the basis of such vehicle and route data, which may be accurately predicted or determined with a relatively high probability. The aforementioned route data may be predicted, for example, by a navigation system in conjunction with a weather forecast and considered for the desired compensation of the no-load losses. Suitable sensors may be used to determine the charge state of the battery.

In the context of the present invention, it has been found in a method that it may be beneficial for the second drive unit to be constituted as an internal combustion engine, the internal combustion engine mechanically compensating the no-load losses in an electrically neutral manner, in an operating state of the electric vehicle in which the charge state of the at least one battery is below a defined threshold value.

In an electrically neutral compensation, loss torques are coordinated in the torque structure, and the electric machine is operated in a way that does not allow any current to flow; in this case, the internal combustion engine uses an additional torque to compensate for the no-load torques. This means that, in an electrically neutral, as well as mechanical compensation, the electric machine may be operated as a generator. The generator torque is thereby selected to make the generated current equal to zero in accordance with a zero current control. The torque that the internal combustion engine requires is preferably composed of the torque required by the driver and the generator torque of the electric motor, which corresponds to the characteristics of the load-point increase. The internal combustion engine thereby mechanically compensates for the losses in an electrically neutral manner. This makes it possible to prevent overdischarging of the battery, which would result in an inadequate supply of electric power for the electric vehicle to subsequently drive the electric machine. Moreover, this makes it possible to prevent an overdischarging or at least a too frequent overdischarging of the at least one battery. By compensating for the no-load losses in accordance with the present invention, respectively by considering the compensation torques accordingly, it is possible to eliminate the need for the driver to readjust the accelerator pedal position in response to a calculation of the torque he/she requires, thereby leading to a more comfortable accelerator pedal feel.

In an inventive method, it is also possible for the second drive unit to be constituted of an internal combustion engine, the internal combustion engine mechanically compensating for the no-load losses in an electrically neutral manner in an operating state in which moving traffic and/or a flat or essentially flat route are/is predicted. This means that, if it is ascertained that the electric vehicle is expected to move on the freeway or an expressway, for example, with little traffic, for example, between 8 pm at night and 6 am in the morning, it may be assumed that there will hardly be an opportunity to recover braking energy. For the aforementioned reasons, the electrically neutral compensation is advantageous for routes having a low recuperation rate (braking energy per kilometer).

In accordance with another embodiment of the present invention, the second drive unit may be constituted as another electric machine, the further electric machine, which is operated as a motor, mechanically compensating the no-load losses in the first drive unit as a function of the predictive route data and/or of the vehicle data of the electric vehicle in an electrically neutral manner. In the case of a motor operation of the further electric machine, no-load losses may be compensated very efficiently, since the further electric machine is already used for the driving or propulsion of the electric vehicle. In this case, the further electric machine fundamentally assumes the above described function of the internal combustion engine. In the described specific embodiment, the first drive unit may also be understood to be the second drive unit, and the second drive unit also to be the first drive unit.

In an operating state of the electric vehicle, in which the charge state of the at least one battery is above a defined threshold value, it is also possible in an inventive method that the at least one battery electrically compensate the no-load losses in a mechanically neutral manner. In the case of a mechanically neutral compensation, the desired torque of the electric machine is equal to zero, and the no-load torques are electrically compensated using electric power from the at least one battery. Energy from a recuperation is more beneficial than energy from a load-point shift, respectively energy that the internal combustion engine converts by combusting fuel from a fuel tank of the electric vehicle. Therefore, selectively using the mechanically neutral compensation makes it possible for the electric vehicle to be operated extremely efficiently.

In an operating state of the electric vehicle in which slow-moving traffic, stop and go, and/or a hilly section are predicted, a further benefit may be derived by the at least one battery electrically compensating the no-load torques in a mechanically neutral manner. This means that, in consideration of predictive routing, for example, it is possible to use a navigation system to predict the points in time when braking energy may be recovered again. This is the case, for example, when the route includes many downhill sections or is an urban route that has many traffic lights. For the aforementioned reasons, the mechanically neutral compensation is advantageous for routes having a high recuperation rate (braking energy per kilometer).

In accordance with another aspect of the present invention, a computer program product is provided that is stored on a data carrier and is designed for executing a method as described in detail above. Thus, the computer program product according to the present invention has the same inherent advantages that were described in detail with reference to the device according to the present invention. The computer program product may be implemented as a machine-readable instruction code in any suitable programming language, such as in JAVA, C++, etc. The computer program product may be stored on a machine-readable storage medium (data disk, removable drive, volatile or non-volatile memory, built-in memory/processor, etc.). The instruction code is able to program a computer or other programmable devices, such as a control unit for an electric vehicle, to perform the desired functions. The computer program product may also be provided in a network, such as the Internet, for example, from where a user may download it as needed. The computer program product may be realized as a computer program, i.e., software, and as one or a plurality of special electronic circuits, i.e., as hardware, or in any desired hybrid form, i.e., as software and hardware components.

Another aspect of the present invention provides a data carrier having a computer program product stored thereon, as was described above. Thus, the data carrier according to the present invention also has the above described inherent advantages.

Moreover, in the context of the present invention, an electric vehicle is provided, having a drive unit constituted of an electric machine, that at least one battery of the electric vehicle supplies with power for a propulsion of the electric vehicle, and having a second drive unit for driving the electric vehicle; a computer program product, as described above, being stored and configured in the electric vehicle to variably compensate for no-load losses in the first drive unit as a function of predictive route data and/or vehicle data of the electric vehicle in accordance with a method described in detail above, in a no-load operation of the first drive unit in which the first drive unit is to provide neither a positive nor a negative torque. Thus, the electric vehicle according to the present invention has the same inherent advantages that were described in detail with reference to the method according to the present invention.

Other refinements of the present invention are derived from the following description of various exemplary embodiments thereof that are schematically illustrated in the figures. All features and/or advantages that derive from the claims, the description or the drawing, including structural details and spatial configurations, may be essential to the present invention, either alone or in any combination. Schematically shown, in each particular case, in:

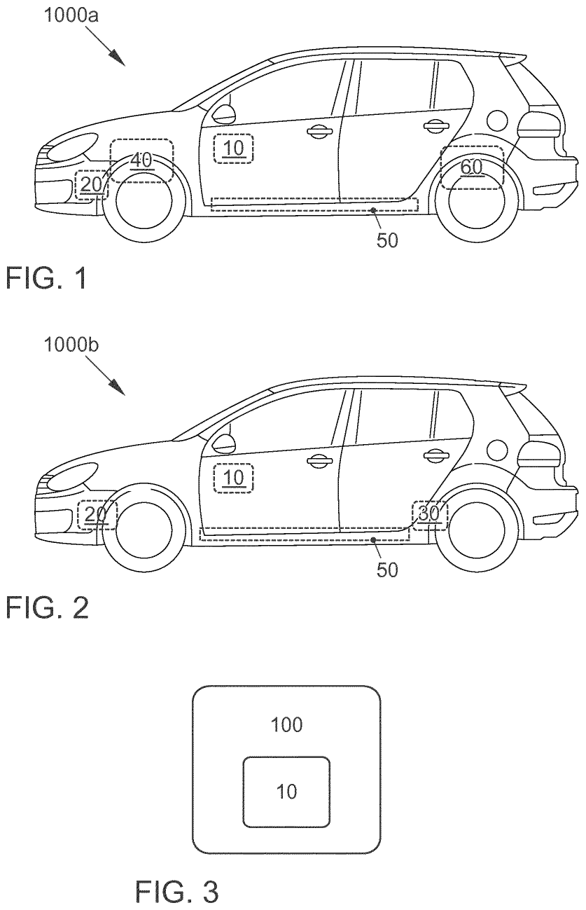

FIG. 1 is an electric vehicle constituted as a hybrid electric vehicle having a computer program product stored therein in accordance with a first specific embodiment of the present invention;

FIG. 2 is a pure electric vehicle having a computer program product stored therein in accordance with a second specific embodiment of the present invention;

FIG. 3 is a data carrier having a computer program product stored thereon in accordance with a specific embodiment of the present invention; and

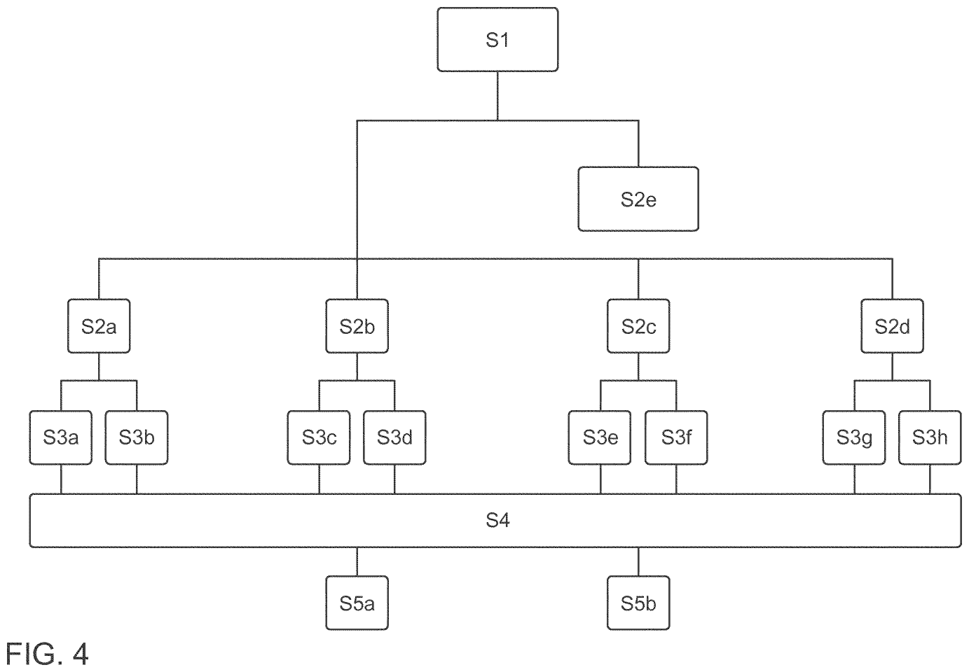

FIG. 4 is a flow chart for clarifying a method in accordance with a specific embodiment of the present invention.

In FIG. 1 through 4, the same reference numerals are provided for elements having the same function and mode of operation.

FIG. 1 shows an electric vehicle 1000a constituted as a hybrid electric vehicle having a first drive unit 20 constituted as an electric machine. For a propulsion of electric vehicle 1000a, the electric machine is energized by a battery 50 of electric vehicle 1000a, respectively supplied with current and voltage. Moreover, electric vehicle 1000a has a second drive unit 40 constituted as an internal combustion engine, which is supplied with fuel from a fuel tank 60 of electric vehicle 1000a. Moreover, a computer program product 10 is stored and configured in electric vehicle 1000a to variably compensate for no-load losses of the electric machine as a function of predictive route data and/or vehicle data of electric vehicle 1000a in a no-load operation of this electric machine in which the electric machine is to provide neither a positive nor a negative torque.

FIG. 2 shows an electric vehicle 1000b constituted as a pure electric vehicle having a first drive unit 20 constituted as an electric machine, as well as a second drive unit 30 constituted as another electric machine. A computer program product 10 is stored and configured in electric vehicle 1000b illustrated in FIG. 2 to variably compensate for no-load losses of this electric machine as a function of predictive route data and/or vehicle data of electric vehicle 1000a in a no-load operation of the first or second electric machine in which the respective electric machine is to provide neither a positive nor a negative torque.

FIG. 3 shows a data carrier 100 having a computer program product 10 stored thereon. Data carrier 100 is constituted as a memory card.

A method for compensating for no-load losses in first drive unit 20 in electric vehicle 1000a illustrated in FIG. 1 is subsequently clarified with reference to FIG. 4. An operating state of first drive unit 20, respectively of the electric machine is determined in a first step S1. If it is ascertained here that the electric machine is in a state in which it is to provide a positive or a negative torque, the method advances to step S2e and may be terminated.

If it is ascertained in step S1 that the electric machine is in a state in which it is to provide neither a positive nor a negative torque, advances to one of steps 2a through 2d.

An elevation profile of a predicted route of electric vehicle 1000a is determined in step S2a. If it is ascertained here that the vehicle will move on a flat or essentially flat route, the method advances to step S3a. In step S3a, the internal combustion engine compensates the no-load losses, preferably in an electrically neutral manner. However, this may require that a fuel tank 60 of electric vehicle 1000a still be sufficiently full or at least be filled to a level higher than a charge of battery 50. The different energy densities of fuel and, for example, of a lithium-ion battery may be considered here. In this regard, the two energy accumulators may be compared, and the comparison evaluated accordingly in a subsequent optional prioritization in accordance with step S4. In accordance with step S5a, the no-load losses may be subsequently compensated in an electrically neutral manner or, in accordance with step S5b, in a mechanically neutral manner.

If it is ascertained in step S2a that electric vehicle 1000a will move on a hilly or mountainous section, the method advances to step S3b. In step S3b, battery 50 compensates the no-load losses in a mechanically neutral manner. The requirement for this is preferably that a charge state of battery 50 still be sufficiently high or at least higher than a corresponding fuel charge in fuel tank 60 of electric vehicle 1000a. In this regard, in accordance with step S4, the two energy accumulators may be compared, and the comparison evaluated accordingly in the subsequent optional prioritization. In accordance with step S5a, the no-load losses may be subsequently compensated in an electrically neutral manner or, in accordance with step S5b, in a mechanically neutral manner.

Step S2b determines a speed profile on a predicted route of electric vehicle 1000a. If it is ascertained here that electric vehicle 1000a will move on an infrequently traveled freeway or expressway, the method advances to step S3c. In step S3c, the internal combustion engine compensates the loss torques in an electrically neutral manner. However, as already described above, this preferably requires that fuel tank 60 of electric vehicle 1000a still be sufficiently full or at least to a level higher than a charge of battery 50. In this regard, in accordance with step S4, the two energy accumulators may be compared, and the comparison evaluated accordingly in the subsequent optional prioritization. In accordance with step S5a, the no-load losses may be subsequently compensated in an electrically neutral manner or, in accordance with step S5b, in a mechanically neutral manner.

If it is ascertained in step S2b that electric vehicle 1000a will move in stop and go traffic or in slow-moving traffic, for example, in rush hour, the method advances to step S3d. In step S3d, battery 50 compensates the no-load losses in a mechanically neutral manner. The requirement for this is preferably that a charge state of battery 50 still be sufficiently high or at least higher than a corresponding fuel charge in fuel tank 60 of electric vehicle 1000a. In this regard, in accordance with step S4, the two energy accumulators may be compared, and the comparison evaluated accordingly in the subsequent optional prioritization. In accordance with step S5a, the no-load losses may be subsequently compensated in an electrically neutral manner or, in accordance with step S5b, in a mechanically neutral manner.

A charge state of battery 50 is determined in step S2c. If it is ascertained here that the charge state is below a predefined threshold value, the method advances to step S3e. In step S3e, the internal combustion engine compensates the no-load losses, preferably in an electrically neutral manner. In addition, a charge state of battery 50 and a filling state of fuel tank 60 may be compared for this purpose, and, in accordance with step S4, the comparison evaluated accordingly in the subsequent optional prioritization. As a function of the evaluation of the comparison, the electrically neutral compensation may, if indicated, be carried out in this case only in consideration of the filling state of fuel tank 60. For example, if there is hardly any fuel in fuel tank 60, while, on the other hand, the charge state of battery 50 is still sufficiently high, the compensation is preferably carried out in a mechanically neutral manner. This means that, following the prioritization in accordance with step S4, the no-load losses are compensated in an electrically neutral manner in accordance with step S5a or in a mechanically neutral manner in accordance with step S5b.

If it is ascertained in step S2c that the charge state is at or above the predefined threshold value, the method advances to step S3f. In step S3f, battery 50 compensates the no-load losses in a preferably mechanically neutral manner.

In step S2d, a filling state of fuel tank 80 of electric vehicle 1000a is determined. If it is ascertained here that the filling state is below a predefined threshold value, the method advances to step S3g. In step S3g, battery 50 compensates the no-load losses in a preferably mechanically neutral manner. In addition, a charge state of battery 50 and a filling state of fuel tank 60 may be compared for this purpose, and, in accordance with step S4, the comparison evaluated accordingly in the subsequent optional prioritization. As a function of the evaluation of the comparison, the electrically neutral compensation may, if indicated, be carried out in this case only in consideration of the charge state of battery 50. For example, if there is still enough fuel in fuel tank 60, while, on the other hand, the charge state of the battery is relatively low, the compensation is preferably carried out in an electrically neutral manner. This means that, following the prioritization in accordance with step S4, the no-load losses are compensated in an electrically neutral manner in accordance with step S5a or in a mechanically neutral manner in accordance with step S5b.

If it is ascertained in step S2d that the filling state of fuel tank 60 is at or above the predefined threshold value and the charge state of battery 50 is below the predefined threshold value, the method advances to step S3h. In step S3h, the no-load losses are compensated, preferably in an electrically neutral manner.

The prioritization in accordance with steps S2a through S2d, respectively S3a through S3h may be performed comprehensively in order to hereby determine whether the no-load losses are to be compensated in an electrically neutral manner in accordance with step S5a or in a mechanically neutral manner in accordance with step S5b. The weighing scenarios described exemplarily above are not to be thereby considered as conclusive or as limiting the present invention. Method steps S2a through S2d, as well as S3a through S3h may be performed serially and/or in parallel.

Additionally or alternatively to the clarified predictive route data, the charge state of the battery, and/or the filling state of the internal combustion engine, other influencing factors, considered individually or in combination, respectively in relation to each other, may be used, as a function of which the no-load losses may be compensated.

### REFERENCE NUMERAL LIST

10 computer program product
20 first drive unit (electric machine)
30 second drive unit (other electric machine)
40 second drive unit (internal combustion engine)
50 battery
60 fuel tank
100 data carrier
1000a, 1000b electric vehicle

1. A method for compensating for no-load losses in an electric vehicle having a first drive unit constituted as a first electric machine, at least one battery for supplying power for a propulsion of the electric vehicle, and a second drive unit for driving the electric vehicle, the method comprising:
operating the first drive unit in a no-load operation; and
in the no-load operation of the first drive unit, variably compensating the no-load losses, as a function of predictive route data and/or vehicle data of the electric vehicle, by providing neither a positive nor a negative torque via the first drive unit.

2. The method as recited in claim 1, further comprising compensating the no-load losses as a function of a charge state of the at least one battery, wherein the predictive vehicle data indicates the charge state.

3. The method as recited in claim 1, further comprising compensating the no-load losses as a function of a predicted elevation profile and/or as a function of a predicted speed profile, wherein the predictive route data indicates the elevation profile and/or the speed profile.

4. The method as recited in claim 2, wherein the second drive unit is constituted as an internal combustion engine, and the method further comprises the internal combustion engine mechanically compensating the no-load losses in an electrically neutral manner in an operating state of the electric vehicle in which the charge state of the at least one battery is below a defined threshold value.

5. The method as recited in claim 3,
wherein the second drive unit is constituted as an internal combustion engine; and
the method further comprises the internal combustion engine mechanically compensating for the no-load losses in an electrically neutral manner, in an operating state of the electric vehicle, in which moving traffic and/or a flat or essentially flat route are/is predicted.

6. The method as recited in claim 1,
wherein the second drive unit is constituted as a second electric machine, the second electric machine is operated as a motor, and
the method further comprises the second electric machine mechanically compensating the no-load losses in the first drive unit in an electrically neutral manner as a function of the predictive route data and/or of the vehicle data of the electric vehicle.

7. The method as recited in claim 2, further comprising the at least one battery electrically compensating the no-load losses in a mechanically neutral manner in an operating state of the electric vehicle in which the charge state of the at least one battery is above a defined threshold value.

8. The method as recited in claim 3, further comprising the at least one battery electrically compensating the no-load losses in a mechanically neutral manner in an operating state of the electric vehicle in which slow-moving traffic, stop and go traffic, and/or a hilly section are predicted.

9. A computer program product, which is stored on a data carrier and is configured to execute a method according to claim 1.

10. A data carrier having a computer program product according to claim 9 stored thereon.

11. An electric vehicle, comprising:
a first drive unit constituted as a first electric machine,
at least one battery configured to supply the first drive unit with power for propulsion thereof,
a second drive unit for driving the electric vehicle;
a computer program product stored in the electric vehicle and configured, to operate the first drive unit in a no-load operation, wherein in the no-load operation, the first drive unit provides neither a positive nor a negative torque in order to variably compensate for no-load losses in the first drive unit as a function of predictive route data and/or vehicle data of the electric vehicle.

12. The electric vehicle of claim 11, wherein the computer program product is further configured to have the first drive unit variably compensate for no-load losses in the first drive unit as a function of a charge state of the at least one battery, wherein the predictive vehicle data indicates the charge state.

13. The electric vehicle of claim 11, wherein the computer program product is further configured to have the first drive unit variably compensate for no-load losses as a function of a predicted elevation profile and/or as a function of a predicted speed profile, wherein the predictive route data indicate the elevation profile and/or the speed profile.

14. The electric vehicle of claim 12, wherein the second drive unit is constituted as an internal combustion engine, and the computer program product is further configured to have the first drive unit variably compensate for no-load losses in an electrically neutral manner in an operating state of the electric vehicle in which the charge state of the at least one battery is below a defined threshold value.

15. The electric vehicle of claim 13, wherein the second drive unit is constituted as an internal combustion engine, and the computer program product is further configured to have the first drive unit variably compensate for no-load losses in an electrically neutral manner in an operating state of the electric vehicle in which moving traffic and/or a flat or essentially flat route are/is predicted.

16. The electric vehicle of claim 11, wherein the second drive unit is constituted as a second electric machine, the second electric machine is operated as a motor, and the computer program product is further configured to have the second electric machine mechanically compensate the no-load losses in the first drive unit in an electrically neutral manner as a function of the predictive route data and/or of the vehicle data of the electric vehicle.

17. The electric vehicle of claim 12, wherein the computer program product is further configured to have the at least one battery electrically compensate the no-load losses in a mechanically neutral manner in an operating state of the electric vehicle in which the charge state of the at least one battery is above a defined threshold value.

18. The electric vehicle of claim 13, wherein the computer program product is further configured to have the at least one battery electrically compensate the no-load losses in a mechanically neutral manner in an operating state of the electric vehicle in which slow-moving traffic, stop and go traffic, and/or a hilly section are predicted.
